(19) United States
(12) Patent Application Publication
(10) Pub. No.: US 2002/0160833 A1
(43) Pub. Date: Oct. 31, 2002

(54) Adapting a game state to be compatible with a new version of a game

(76) Inventors: David B. Lloyd, Cambridge (GB); Mark Tillotson, Cambridge (GB)

Correspondence Address: PERKINS COIE LLP, PATENT-SEA, P.O. BOX 1247, SEATTLE, WA, 98111-1247, US

(21) Appl. No.: 10/032,711

(22) Filed: Oct. 25, 2001

Related U.S. Application Data
(60) Provisional application No. 60/243,209, filed on Oct. 25, 2000.
(60) Provisional application No. 60/243,697, filed on Oct. 25, 2000.

(51) Int. Cl. A63F 13/00

(52) U.S. Cl. 463/29

(57) ABSTRACT

A facility for adapting states used with a first version of a game for use with a second version of a game is described. The facility compares the first and second versions of the game to identify dependencies on the state of the second version of the game not shared by the first version of the game. The facility automatically generates a rule to modify states used with the first version of the game to satisfy the identified dependency. For each of one or more states used with the first version of the game, the facility applies the generated rule to the state to adapt the state for use with the second version of the game.

### CROSS REFERENCE TO RELATED APPLICATION

This application claims the benefit of U.S. Provisional Application No. 60/243,209 filed on Oct. 25, 2000, which is hereby incorporated by reference in its entirety.

### TECHNICAL FIELD

The present invention is directed to the field of software development tools, and, more particularly, to the field of computer-implemented game development tools.

### BACKGROUND

A wide variety of games have been implemented in computer-based systems. Examples include shooting games; adventure games; role-playing games; card , word, logic, and board games; sports games; navigation games in which players maneuver on foot or in a vehicle; and gambling games. Games such as these have been implemented in different types of computer-based systems, including single-game systems, such as arcade games; multiple-game dedicated gaming systems, such as gaming consoles and handheld gaming systems; and general-purpose computer systems.

A game is typically implemented in a computer-based system by creating one or more computer programs, collectively called the game's “code base.” These programs, which each comprise a set of instructions executed by a microprocessor or similar device, typically receive input from one or more users and render output to those users. For example, in a tic-tac-toe game, a user may supply input selecting a square in which to place his or her mark. Such input may be received via a variety of input devices, such as a keyboard; a position-based pointing device such as a mouse, trackball, touch pad, or touch screen; a directional pointing device such as a joystick; or an audio sensing device such as a microphone for sensing voice or other sounds. In response, if an open square was selected, the game may render output showing the user's mark in the selected square. Additionally, if placing the user's mark in the selected square caused the user to win the game, the game may further render output delivering a message to that effect. Such output may be conveyed via a variety of output devices, such as a visual display device or an audio output device.

The output rendered by a game in response to particular input is often generated by applying rules to the combination of that input and data—called the game's “state”—indicating what has happened so far in the game. The result of applying rules to the combination of input and state may yield particular output, and/or changes to the state. In a tic-tac-toe game, the state may indicate, for each of the nine squares, a status indicating whether it is open, occupied by the first of the two players, or occupied by the second of the two players. The code base may use this state to determine, for a newly-selected square, (1) whether the selection is a legal move (i.e., whether the selected square is open), and (2) whether selection of the square caused the selecting player to win the current game.

In some cases, state is maintained for an extended period of time, either in memory or in external storage devices, enabling a user to progress further and further into a game, such as traversing greater areas in a navigation game. This also enables users who only have occasional and brief opportunities to play a game to nonetheless progress beyond the beginning of the game.

By modifying a game's code base after it is released for use by users, the game's developer can create new versions of the game. The developer may make such modifications to the earlier-released code base for a variety of reasons. As one example, the developer may modify the code base for maintenance purposes, such as to fix a bug, improve performance, or ensure compatibility with additional kinds of hardware components. The developer may also modify the code base to add features. For example, the developer may revise the code base for the tic-tac-toe game to enable users to place their mark in squares arrayed in three dimensions rather than two.

With respect to a particular set of revisions to a code base, the version of the code base to which the revisions are made is called the “existing code base” herein, while the version of the code base reflecting the revisions is called the “revised code base.” It is noted that a single version of the code base may constitute the existing code base with respect to one set of revisions, while constituting the revised code base for another set of revisions. For example, among versions 1, 2, and 3 of a code base, where version 2 is produced by applying a first set of revisions to version 1 and version 3 is produced by applying a first set of revisions to version 2, version 2 is both the revised code base with respect to the first set of revisions and the existing code base with respect to the second set of revisions. Relative to each other, a first version of a code base is said to be “earlier” than a second version if the second version is generated by applying one or more sets of revisions to the first version, and “later” than a second version if the first version is generated by applying one or more sets of revisions to the second version. For example, as between versions 1 and 3 above, version 1 is the earlier code base and version 3 is the later code base.

Where a revised code base is developed from an existing code base, the revised code base may have different expectations of the game's state than the existing code base. For example, before the revision of the tic-tac-toe game's code base to add a third dimension, the existing code base would expect the state to contain status for each of 9 squares, while after revision the revised code base would expect the state to contain status for each of 27 squares. As part of the revision to the code base, the revised code base is modified to initialize the state at the beginning of the game to contain status for each of 27 squares. Accordingly, where a particular state is created by the revised code base, this state will be compatible with the revised code base and its expectation that the state will contain status for each of 27 squares. Where a user attempts to use with the revised code base a state created by the existing code base that contains status for each of 9 squares, however, the revised code base's expectation that the state will contain status for each of 27 squares is not satisfied.

Failure of a state to satisfy expectations of a code base is referred to herein as incompatibility of the state with the code base. Attempts to use with a revised code base a state that is incompatible with the revised code base can produce a variety of unpleasant results. In some cases, the revised code base may identify the state as incompatible and refuse to use it, thus preventing the user from playing the game. Worse, the revised code base may execute, but misinterpret some parts of the state, yielding erratic game play. Worse still, the revised code base, and therefore the game, may freeze or abort at some point when trying unsuccessfully to access elements of the state.

These problems often make it difficult or impossible to continue to play with a later code base a game whose state was generated by an earlier code base. In such a case, users must decide between (1) continuing to use the earlier code base in order to continue to use the state that they've generated, thereby foregoing any advantages of the later code base; and (2) using the later code base to avail themselves of its advantages, but not being able to continue to use their game state. In some instances, users are unable to control which version of the code base is used, and must use the revised version of the code base, preventing them from continuing to use their game state irrespective of their wishes.

Accordingly a facility that automatically facilitates the use with a later version of a game state generated with an earlier version of the game would have significant utility.

### BRIEF DESCRIPTION OF DRAWINGS

FIG. 1 is a block diagram showing some of the components typically incorporated in at least some of the computer systems and other devices on which the facility executes.

FIG. 2 is a flow diagram showing steps typically performed by the facility in order to save the current game state.

FIG. 3 is a flow diagram showing steps typically performed by the facility in order to analyze a new version of the code base.

FIG. 4 is a flow diagram showing steps typically performed by the facility to adapt a saved state for use by a revised version of the code base.

### DETAILED DESCRIPTION

A software facility for adapting a game state to be compatible with a new version of a game (“the facility”) is provided. In some embodiments, the facility is applied to the code base any time it is revised to ensure the adaptation of game states to be compatible with the revised code base. For example, the facility may be automatically applied to revised code bases when they are submitted by a developer to a compiler or translator, or checked into a version control system.

Embodiments of the facility compare the revised code base to the existing code base to identify any differences between the two code bases, which correspond to the set of revisions made to the existing code base to create the revised code base. Among these differences, the facility selects those that create new dependencies on the game state relative to the dependencies of the existing code base on the game state. For each selected difference, the facility typically notifies the developer, enabling the developer to resolve all sources of incompatibility of states generated by the existing code base with the revised code base. For each selected difference, the facility typically also generates a suggested state modification rule for adapting a state generated with the existing code base to satisfy the new dependencies. The state modification rules typically may modify a game state in a variety of ways, including deleting or rearranging data, and adding new data based upon either static data or other data found in the game state. The developer may typically edit the suggested rules after they have been generated. The facility stores the state modification rules, as edited, with an indication that they relate to the current set of revisions.

In instructions used by the revised code base to load a saved state, the facility determines whether the saved state was generated using the existing code base. If so, the facility (1) applies the stored state modification rules to the state in conjunction with loading it to adapt the state for use by the revised code base, and (2) marks the adapted state as being generated by the revised code base, so that the stored state modification rules are applied no more than once to any state.

In this way, the facility enables a game state generated with an existing code base to be used with a revised code base, thus circumventing the disadvantages of conventional approaches. In some embodiments, the facility maintains a history of state modification rules stored for several sets of revisions to the code base, enabling the facility to modify for use with a particular version of the code base a state generated with a version of the code base that is several versions earlier.

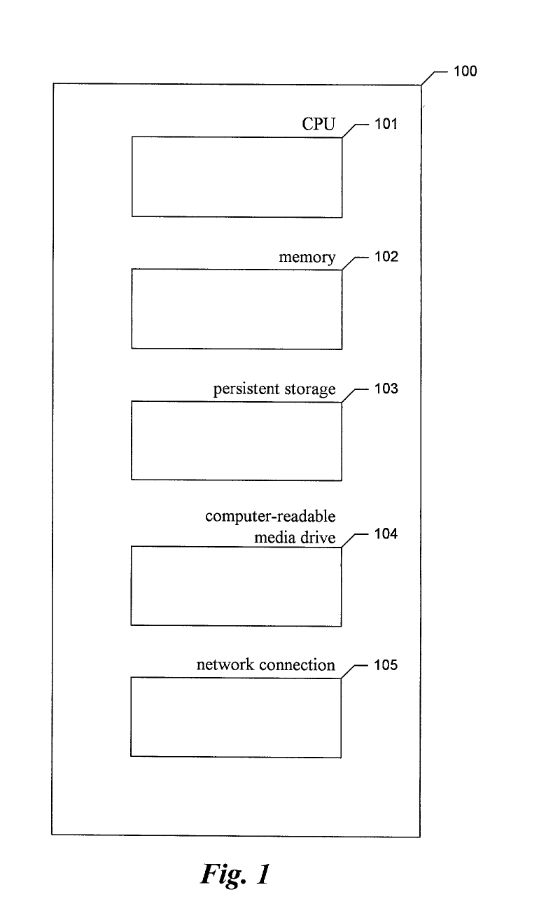

FIG. 1 is a block diagram showing some of the components typically incorporated in at least some of the computer systems and other devices on which the facility executes. These computer systems and devices 100 may include one or more central processing units (“CPUs”) 101 for executing computer programs; a computer memory 102 for storing programs and data while they are being used; a persistent storage device 103, such as a hard drive for persistently storing programs and data; a computer-readable media drive 104, such as a CD-ROM drive, for reading programs and data stored on a computer-readable medium; and a network connection 105 for connecting the computer system to other computer systems, such as via the Internet. While computer systems configured as described above are preferably used to support the operation of the facility, those skilled in the art will appreciate that the facility may be implemented using devices of various types and configurations, and having various components. In particular, the facility may be implemented in any computer system or other device on which the code base is developed or deployed, or on various other computer systems or devices that interact with these computer systems or devices.

Embodiments of the facility include a mechanism that any version of a code base can use in order to save its state. While a game is being played, it is common for the game's code base to maintain the corresponding game state either in memory or in a memory-mapped file that may be accessed like memory. At some points, the code base may need to store this game state in a more permanent form. For example, the code base may wish to periodically save the state as a precaution against hardware outages or other disruptions of the computer system's memory. The period employed for periodic saves may vary based upon the rate at which change occurs to the state. For example, a game having very rich dynamic content, and/or played by a large number of players simultaneously, may require saving more frequently than less intensive games. The code base may also need to save the game state on demand when interruption of the execution of the code base is expected. For example, such interruptions may occur for maintenance, to use the computer system for another purpose, or to install a new version of the code base.

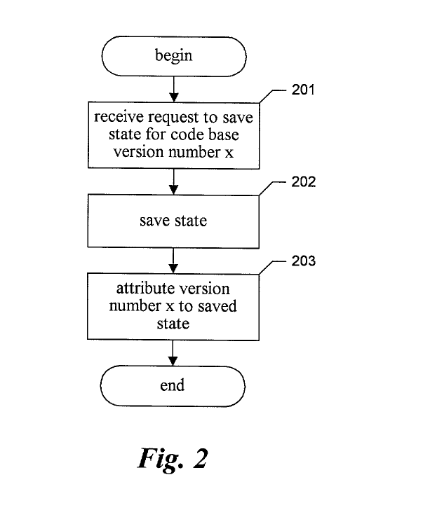

FIG. 2 is a flow diagram showing steps typically performed by the facility in order to save the current game state. It is typical for each version of the code base to invoke this functionality of the facility in order to save its state. In step 201, the facility receives a request to save the current game state. The request includes an indication of the version number of the code base issuing the request. In step 202, the facility saves the current state in a permanent form. This process, called “serialization,” is discussed in detail below. In step 203, the facility attributes to the state saved in step 202 the version number of the invoking code base. After step 203, these steps conclude.

In order to determine whether each new version of a code base will necessitate corresponding changes to game states currently in use, for each new version of the code base, the facility typically analyzes the differences between the new version and the immediately preceding version to identify any new or changed dependencies of the code base on the state.

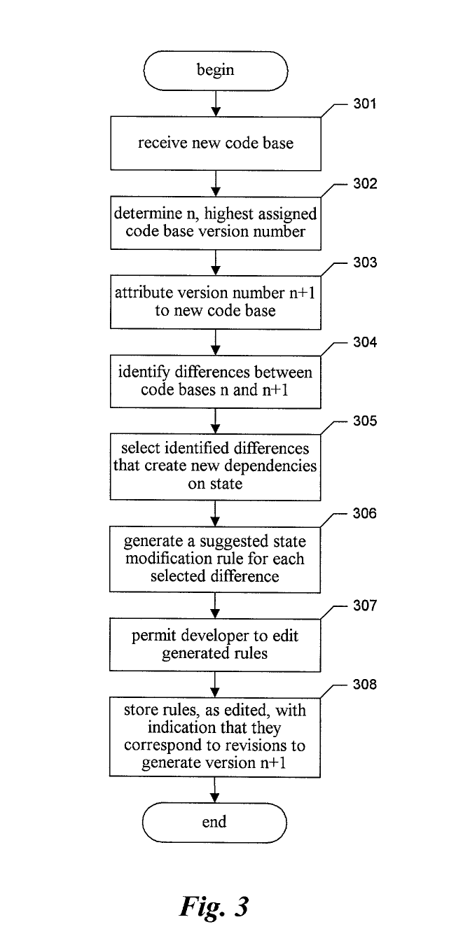

FIG. 3 is a flow diagram showing steps typically performed by the facility in order to analyze a new version of the code base. In some embodiments, these steps are performed as part of a compilation process that is an important, if not essential, part of the process of developing a new version of the code base. In step 301, the facility receives the new code base. In step 302, the facility determines the highest version number already assigned to a code base, and stores this version number as n. In step 303, the facility attributes version number n+1 to the new code base received in step 301. In step 304, the facility identifies any differences between code bases and n+1. This step, and the remaining steps in FIG. 3, are discussed in greater detail below. In step 305, among the differences between the code bases identified in step 304, the facility selects those that create new or changed dependencies on the game state.

Tables 1 and 2 show an example of a difference selected in step 305.

These examples, and others occurring herein, are expressed in a specialized game programming language described further below.

Table 1 shows an example code fragment from an existing version of the code base.

TABLE 1
archetype Door from Partition

attribute State { open closed }

Table 2 below shows an example of the corresponding code fragment in a revised version of the code base.

TABLE 2
archetype Door from Partition

attribute State { open closed }
attribute Toughness Int

Each of these code fragments is a class definition for a class called Door, which is derived from a class Partition. In the existing code base, the class Door is defined to have a single data member, or “attribute,” called State, which has possible values open and closed. The code fragment from the revised code base adds a second attribute, Toughness, to the class definition for the class Door. The Toughness attribute is of type Integer. This change in the code base introduces the following new dependency on the game state: objects of class Door in the game state are now expected to have a value for the attribute Toughness. No game state generated by the existing version of the code base will have such an attribute value.

In step 306, the facility generates a suggested state modification rule difference selected in step 305. Where the difference is the addition of an attribute to an existing class, the suggested state modification rule typically generated by the facility is one that initializes the new attribute to a default value. For the examples shown above in Tables 1 and 2, the facility might generate the state modification rule shown below in Table 3.

TABLE 3
archetype Door

update

Toughness = 0

Because the Toughness attribute is an integer, the suggested state modification rule initializes this attribute to a default value for the integer type, 0. The rule shown in Table 3 is referred to as an “update rule,” because it merely involves changing or augmenting data that has been loaded into the state class hierarchy in the same locations from which it was saved. “Conversion rules,” on the other hand, are those that are used to map data from a saved state to different points in the state class hierarchy than those from which they were saved.

Tables 4 and 5 shown an example relating to a conversion rule. Table 4 below shows an example code fragment in a revised version of the code base corresponding to the example code fragment from an existing version of the code base shown in Table 1.

TABLE 4
archetype BasicDoor from Partition

attribute State { open closed }

archetype Door from BasicDoor

Table 4 shows that the attribute State has been moved from the Door class to a new BasicDoor class, from which the Door class now inherits. For the example shown above in Tables 1 and 4, the facility might generate the State modification rule shown below in Table 5.

TABLE 5

convert Door

assert State new (State old) # the State attribute is

still meaningful it has just changed position in the hierarchy

The State modification rule shown in Table 5 specifies that, within the Door class, values of the attribute State that are native to the Door class are to be copied, or “transferred,” to the State attribute that is inherited by the Door class.

In step 307, the facility permits the developer to edit the generated rules. In the case of the example shown in Table 3, the developer may wish for doors that do not yet have a value for Toughness to receive a value greater than 0, and may therefore edit the suggested state modification rule shown in Table 3 in order to produce the state modification rule shown below in Table 6.

TABLE 6
archetype Door

update

Toughness = 20

In step 308, the facility stores the rules, as edited, with an indication that they correspond to revisions made in order to generate version n+1 of the code base. After step 308, these steps conclude.

Game states are typically unaffected by the facility until they are loaded by a later version of the code base than that by which they were last saved. When this occurs, the facility applies any state modification rules needed in order to adapt the state for use by the code base that loaded it.

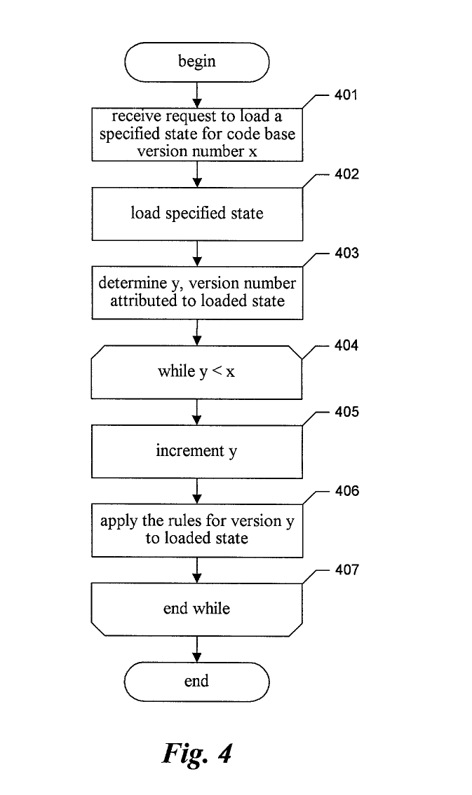

FIG. 4 is a flow diagram showing steps typically performed by the facility to adapt a saved state for use by a revised version of the code base. In step 401, the facility receives a request to load a specified saved game state. The request identifies the version number of the code base issuing the request, which is stored in variable x. In step 402, the facility loads the state specified in the received request. In step 403, the facility determines the version number attributed to the loaded state, and stores it in variable y. Steps 404 and 407 cause the facility to repeat steps 405 and 406 while y is less than x. In step 405, the facility increments y. In step 406, the facility applies to the state loaded in step 402 the state modification rules stored for version y in step 308 shown in FIG. 3. In step 407, the facility loops back to step 404 to repeat the test that determines whether y is still less than x. After step 407, these steps conclude, and the code base that requested that the state be loaded is permitted to use the state, as modified by the application of rules in step 406.

Additional detail on the organization, saving, and loading of a game state is discussed below. Aspects of this discussion relate to a specialized game development environment and language. U.S. patent application Ser. No. 60/243,697, filed on Oct. 25, 2000 and entitled “ELECTRONIC GAMING LANGUAGE REFERENCE,” and International Patent Application No. PCT/US01/______, entitled “ELECTRONIC GAME PROGRAMMING SYSTEM”, filed Oct. 25, 2001 (Attorney Docket No. 34500-8001 WO00), which describe further aspects of this language, are each hereby incorporated by reference in its entirety.

The “game world” is a heap or graph of objects representing game state for many users, including local and global state, thus supporting multi-player games with real-time interaction between game users (players).

This world has a dynamic existence in the working memory of a live game server, but can be serialized to backing store also.

By saving to backing store and retrieving to the same or another server, the game state(s) persist across such eventualities as power and equipment failure and the need to upgrade hardware or move to a different server.

The software comprises two conceptual parts, the game-server engine, responsible for connecting user requests and sessions to the game logic, and the game logic, operating on and modifying the state in the heap or graph.

The game logic uses an object-oriented approach, specifically utilitizing encapsulation, inheritance and classes. Thus objects in the heap are typed and each have a class and there exists a relationship between a class and its super-class.

The software comprising the game logic is conceptually in two parts also, that defining the schema, or data structures, and that providing the computation of values and execution of updates to the state.

In the course of time the software changes to effect enhancements and fix problems in a particular game. Concurrently a population of users are each playing on a particular game world and assuming the state for them (any other players they interact with) will survive the process of software change.

A more traditional approach would use a separate database for maintaining persistent state, and thus have substantial overheads for state-probing and updating. The database would have to be updated as the schema evolved and this would be a manually controlled redefinition of the database, probably in a language like SQL, and not linked to the language in which the game logic was coded.

By incorporating primitives into the games programming language to support change of the schema, and having the compiler support automatic re-configuration of the data, a much more flexible, fast and error-free system for supporting persistent state for the games system.

When a games server is supporting 100,000's of users, with 1,000's active at one point in time, it is very important that each user's requests and interactions take a minimum of resources from the server. There is only a small monetary value to each such “transaction” and to be economical viable a server must be able to provide for a very great number of users.

In order to provide a multi-player experience it is important that large numbers of player access a single server—otherwise at quiet times of day the critical mass for rendezvous with other human players within an acceptable wait-time will not materialize.

Modern mobile devices are providing an ever increasing variety of low-power computing devices into peoples hands, but in many limited and incompatible forms. It makes great sense to perform games logic on a server and restrict the client-side to UI and presentation. This keeps client-code small, allows for multi-player and complex games, and obviates the need for any backup or personalization of the portable device. Of course much of this argument applies to any form of software for connected mobile devices of low power.

The schema for such a game system consists of a series of definitions of data structures. class or archetype definitions describe the types of objects in terms of what primitive attributes are associated with objects of that type, and which type or types they inherit from. Changes such as adding a new attribute to an archetype are minor and simply require a rule for initializing the new attribute. Changes such as changing what type you inherit from are potentially very major, since inherited attributes are lost and gained wholesale. In the heap there are no direct pointers from objects to other objects—all such references are represented by a more general mechanism, the relation. A relation is a typed grouping of objects according to some predefined list of types. Such a group of objects of the relevant types can be “asserted” into the relation, or “retracted” from it. At any time there exist any number of such groupings, and crucially each object can take part in many such groupings. This notion is more general that pointers (references) and in fact subsumes many data-structures typically used in programming languages (other than logic programming languages). Relations are much more resistant to schema evolution because of their general nature. In fact they represent a middle ground from the more static world of relational databases and the imperative programming languages.

As an example, rather than having to change existing data-structures when a new “pointer” is required in a traditional data-structure, adding a new relation to represent that pointer involves no change, merely the definition of a new relation over the types concerned.

Embodiments of the facility save the state of a running game—a “heap” of objects with attributes and relations between them—to an external file. This process is referred to herein as “serialization” of the game state. Serialization of a game state may be accomplished in a variety of ways, including using the standard Java Object Serialization facility. Java Object Serialization is described in http://java.sun.com/j2se/1.3/docs/guide/serialization/index.html, and in the Java Language Reference the section on Binary Compatibility http://java. sun. com/docs/books/jis/second_edition/html/binaryComp. doc. html#448 72. Serialization may also be performed using a custom serialization approach that is particularly well-adapted to serializing game states.

The format of the serialized file is designed to be read back in and regenerate an equivalent heap in an efficient manner on the same or another instance of the games engine. The efficiency is such that a world containing objects representing tens of thousands of players can be saved and restored in seconds on current generation computer hardware. The method is designed to scale linearly with the number of objects saved.

The serialized file format as shown below in Table 7.

TABLE 7

| | |
|---|---|
| A) | A “magic number” to identify the file format |
| B) | a count of the number of distinct classes (object types) represented in |
| | the dumped world. |
| C) | a table listing for each class its (a) index, (b) full name |
| D) | a table listing for each class its |
| | (i) index |
| | (ii) superclass full name |
| | (iii) persistent field table (names and types/classes) |
| E) | a count of the object instances |
| F) | a table giving the class index for every instance |
| G) | An optional table of global objects (list of indices) |
| H) | a linear dump of the persistent fields for all instances in order, the |
| | class's field table defines the order for each instance type |

The coding for particular values is such that you need to know the intended value type in order to interpret the serialized string of bytes that represents it—in order words the context always implies the type.

Firstly there is a compact bytecoding for simple primitive values (integers, floating point numbers). For instance integers in the range −64.63 are coded in 1 byte, integers in the range −8192 . . . 8191 in 2 bytes, etc. This coding is used for any integer values whether an integer from the world or one used in the serialization housekeeping (such as a table length count).

Composite primitive values such as 2D and 3D vectors and character strings are coded conditionally depending on whether the value is null or not. A single byte codes the null case, otherwise individual fields are output in a known order. Variable length types like string have a length value first.

References to objects consist of a (coded) integer index into a table, with a distinguished value representing “null”.

The information in parts C), D), F) and H) facilitates the rapid restoring of a world from the serialized form without unnecessary computation.

The overall format, although efficient to dump and restore, is also compact, typically taking up 10% of the size of the heap on a machine with 32-bit pointers for actual game worlds.

This file format can be used in two ways. First, the file format may be used to dump an entire world, with the first (index 0) instance being the World object. A breadth-first traversal is used to find all the instances to be dumped, and then the file's parts are written out using tables of classes and instances built during traversal.

A running world is typically suspended during this process.

A special field in every object in the world is typically employed to remember its index in the table and to test whether the traversal has met the object yet. This helps to ensure linear scalability of world-saving.

The second mode of use of the file format is to dump a part of the world, and this is the mode that includes the global objects table (G). Here a breadth-first traversal from a local root is performed, which is terminated at any instances that are in the global objects table. Thus, local state for a player can generally be dumped using this file format without causing any global game state to be wastefully saved with it. Using a breadth-first traversal prevents the traversal algorithm from using more than a constant-bounded amount of stack space, necessary for scalability to large worlds on certain platforms.

Reloading an entire world involves simply building a large array of all the instances, pre-allocating each instance, and then calling a method for each one to read the linear-dump. By checking that the class's field-table matches the current version of the game engine software, it is possible to use a compiler-generated specific method for reading the linear dump to fill a particular object, thus achieving great efficiency in the case where no or little update to the world's schema has happened since the world was serialized.

If at load time the field-table for a class has changed, more generic (but slower) code is used to interpret each part of the linear dump according to the new class's fields and the dumped field table.

Kinds of changes between archetypes:

attributes:

new attribute

needs initial value expression

remove attribute

might want to say what to do with the information

(maybe its going into a relation)

change type

could be remove, add new

could be that the type has been wrapped in another

want rule for rewriting value in terms of old

archetype

new superclass

lots of attributes might thus disappear or appear . . .

maybe various relations need updating

relation

new shape—more or fewer

need to know how to move relation-members across

in some sense parts of relation are like attributes or an archetype

new types

might be OK, if inheritance-related types, otherwise

reject bad ones?

new indices or representation

Thus a fairly generic update rule syntax.

This kind of object is changing, define change as an action on the old and new object. Use object deserializer as hook to find all objects of a given type, and create new versions from old data.

Want to be able to specify an order in which rewrite rules apply—thus by default apply the rules type-by-type in the order provided, but might want one rule to be in charge of another and explicitly request update on other objects.

Perhaps the best method is to use a lazy-ordering of update, akin to Java's static initialization protocol. This requires each type (and instance) to have a flag recording if it is updated. The update protocol lazily forces update of all data read (this means attributes read) from the new world-view. Also the old world view must be simultaneously available, implying a relation exists from new to old objects. Maintain invariant that new objects can only refer to new ones and propagate through the relations. The special old-new relation can then always get at the old version.

Top level compiler Compare

Takes current and old source trees, writes file UpdatesOutline.sin loop through the old world's globals . . .

For the old symbol lookup in new world

note if it has gone away

note if the symbol has changed type (say from global constant to an action . . . )

if the new_symbol.changeInorable ( ), then ignore

if the symbol is a verb, and if the old and new versions are not equal( ), fatal error, change in verb syntax.

if new symbol is an archetype

assume old is archetype too,

call archetype compare

if a minor, major or update-supplied change, mark the world as having changed

if a major change, fatal error, not compatible

if a minor change and no update method supplied, whinge fatally

if an update supplied, warn that the archetype will be updated.

then loop through globals noting the new globals that are extra bump world versions if any world change.

Archetype compiler Compare

ignore if old archetype is null (just for AnyThing?)

If old parent isn't current parent (compare lexemes for EQ), (ignoring AnyThing case),

then MAJORchange

Then collect all the direct attributes in a hashtable, deleted attributes in a Vector

find any attributes that have changed types, and record these as MAJOR change

deleted or new attributes are MINORchanges

If now update method, compose one for all the deleted and new attributes

with comments for deleted, new, plus “newvalue=#” clauses for new ones

update archetype version if any change,

copy old SUID only if no major change.

It will be understood by those skilled in the art that the above-described facility could be adapted or extended in various ways. For example, the facility may be straight forwardly adapted to operate with various gaming platforms, operating systems, languages, and game states. The facility may employ different logic, syntax, etc. that is necessary or desirable in these different environments. While the foregoing description makes reference to preferred embodiments, the scope of the invention is defined solely by the claims that follow and the elements recited therein. Further, it will be recognized that analysis between two versions of a code base may be performed at times other than compilation time, and that adaptation of a state may be performed at times other than state load time.

I/we claim:

1. A method in a computing system for adapting saved states used with a first version of a game for use with a second version of the game, comprising:
comparing source code for the first version of the game to source code for the second version of the game to identify changes from the source code for the first version of the game to the source code for the second version of the game;
among the identified changes, selecting those that add a new dependency on state;
for each selected change, automatically generating a state modification rule that satisfies the new dependency added by the change;
storing the state modification rules together; and
in instructions used by the second version of the game to load saved states:
loading the current saved state;
determining whether the current state is used with the first version of the game; and
if the current state is used with the first version of the game:
retrieving the stored state modification rules;
in conjunction with loading the current state, applying the retrieved state modification rules to modify the loaded state; and
identifying the loaded state as being used with the second version of the game.

2. A method in a computing system for adapting states used with a first version of a game for use with a second version of the game, comprising:
comparing the first and second versions of the game to identify dependencies on the state of the second version of the game not shared by the first version of the game;
automatically generating a rule to modify states used with the first version of the game to satisfy the identified dependency; and
for each of one or more states used with a first version of the game, applying the generated rule to the state.

3. The method of claim 2 wherein the generated rule is applied to each state in response to an attempt to use the state with the second version of the game.

4. A method in a computing system for analyzing a new version of a computer program, comprising:
comparing state data definitions of the new version of the computer program with state data definitions in a previous version of the computer program; and
if the comparison indicate that a data item moved in the state data hierarchy from an old location to a new location, generating an indication that, when state data generated by the previous version of the computer program is to be used with the new version of the computer program, the data item should be mapped from the old location to the new location.

5. The method of claim 4, further comprising, if the comparison indicate that a data item in the state data definitions of the previous version of the computer program does not occur in the state data definitions of the new version of the computer program, generating an indication that, when state data generated by the previous version of the computer program is to be used with the new version of the computer program, the data item should be represented in a different way in the state data for the new version of the computer program.

6. The method of claim 4, further comprising, if the comparison indicate that a data item in the state data definitions of the new version of the computer program does not occur in the state data definitions of the previous version of the computer program, generating an indication that, when state data generated by the previous version of the computer program is to be used with the new version of the computer program, the data item should be assigned a starting value in the state data for the new version of the computer program.

7. The method of claim 4 wherein the state data is stored on a heap.

8. The method of claim 4 wherein the computer program is a game.

9. The method of claim 4 wherein the data item is a global data item.

10. The method of claim 4 wherein the data item is a data member of an object class.

11. A computer-readable medium whose contents cause a computing system to adapt states used with a first version of a game for use with a second version of the game by:
comparing the first and second versions of the game to identify dependencies on the state of the second version of the game not shared by the first version of the game;
automatically generating a rule to modify states used with the first version of the game to satisfy the identified dependency; and
for each of one or more states used with a first version of the game, applying the generated rule to the state.

12. A computing system for analyzing a new version of a computer program, comprising:
a comparison subsystem that compares state data definitions of the new version of the computer program with state data definitions in a previous version of the computer program; and
a recommendation subsystem that, if the comparison indicate that a data item moved in the state data hierarchy from an old location to a new location, generates an indication that, when state data generated by the previous version of the computer program is to be used with the new version of the computer program, the data item should be mapped from the old location to the new location.

13. A method in a computing system for generating rules relative to a game whose code base has been revised from an old version to a new version that has new dependencies on state, comprising:
constructing a rule that, when applied to a game state generated by the old version of the game's code base, will modify the game state to satisfy the new dependencies on state introduced by the new version of the game's code base;
storing the constructed rule; and
storing an indication that the stored rule is to be applied to a game state generated by the old version of the game's code base that are to be used with the new version of the game's code base.

14. The method of claim 13, further comprising:
receiving user input; and
modifying the constructed rule in accordance with the user input before storing the constructed rule.

15. The method of claim 13, further comprising, when the new version of the game's code base loads a state generated by the old version of the game's code base, applying the stored rule.

16. The method of claim 15 wherein the stored rule is applied in the absence of user input.

17. One or more computer memories collectively containing a game state update rule data structure, comprising:
(a) information usable to select one or more data items in a game state generated by a first version of game code; and
(b) information identifying a transformation on selected data items in a game state generated by the first version of game code, the transformation satisfying a dependency of a second version of game code on game state,
such that, when a distinguished game state generated by the first version of game code is to be used by the second version of game code, (a) can be used to select in the distinguished game state data items to be transformed, and (b) can be used to transform the selected data items to satisfy a dependency of a second version of game code on game state.

18. The computer memories of claim 17 wherein (b) identifies a transformation that initializes a new component of the selected data items.

19. The computer memories of claim 17 wherein (b) identifies a transformation that relocates the selected data items from an initial location within the game state to a new location within the game state.

20. A method in a computing system for applying game state modification rules to game states used by a game, comprising:
when a game state is loaded by a present version of the game, reading an indication of the version of the game with which the game state is compatible;
if the read indication indicates that the game state is compatible with a version of the game earlier than the present version, modifying the loaded game state by:
selecting one or more game state modification rules indicated to transform game states compatible with the version of the game indicated by the read indication into game states compatible with the present version of the game; and
applying the selected game state modification rules to the loaded state.

21. The method of claim 20, further comprising, if the read indication indicates that the game state is compatible with a version of the game earlier than the present version of the game, modifying the loaded game state by modifying the indication of the version of the game with which the game state is compatible to indicate that the game state is compatible with the present version of the game.

22. The method of claim 20 or 21 wherein the loaded game state is only modified if the read indication indicates that the game state is compatible with a version of the game earlier than the present version of the game.

23. The method of claim 20 wherein the selected game state modification rules include both (1) one or more game state modification rules indicated to transform game states compatible with the version of the game indicated by the read indication into game states compatible with an intermediate version of the game, and (2) one or more game state modification rules indicated to transform game states compatible with the intermediate version of the game into game states compatible with the present version of the game.

24. A computer-readable medium whose contents cause a computing system to apply game state modification rules to game states used by a game, comprising:
when a game state is loaded by a present version of the game, reading an indication of the version of the game with which the game state is compatible;
if and only if the read indication indicates that the game state is compatible with a version of the game earlier than the present version:
selecting one or more game state modification rules indicated to transform game states compatible with the version of the game indicated by the read indication into game states compatible with the present version of the game; and
applying the selected game state modification rules to the loaded state; and
modifying the loaded game state by modifying the indication of the version of the game with which the game state is compatible to indicate that the game state is compatible with the present version of the game.

25. A method of serializing a set of object instances residing on a heap, comprising:
visiting object instances residing on the heap by traversing the heap in breadth-first order;
for each object instance visited as part of the traversal, adding the class and data member values of the visited object instance to an intermediate data store; and
generating a stream representation of the set of object instances from the contents of the intermediate data store.

26. The method of claim 25 wherein adding the class and data member values of the visited object instance to an intermediate data store comprises:
if the class identifier of the class of the visited object instance is not contained in a class table, reading a class index listed for the class identifier in the class table, and writing to an instance table the read class index and the data member values of the visited object instance;
if the class identifier of the class of the visited object instance is not contained in a class table, adding a class index to the class table for the class identifier, and writing to an instance table the added class index and the data member values of the visited object instance.

27. The method of claim 26 wherein adding the class and data member values of the visited object instance to an intermediate data store comprises, if the class identifier of the class of the visited object instance is not contained in a class table, adding to a second class table:
the class index added to the class table for the class identifier,
a class identifier of the superclass of the class of the visited object instance; and
a table of the persistent fields of the class of the visited object instance.

28. The method of claim 25, further comprising:
when the class and data member values of an object instance are added to the intermediate data store, setting an already-visited flag of the object instance,
and wherein the class and data member values of an visited object instance are added to the intermediate data store only if the already-visited flag of the object instance is not set.

29. The method of claim 25 wherein the serialized object instances collectively represent the state of a game.

30. One or more computer memories collectively containing a serialized object data structure representing a plurality of object instances, comprising:
a first table listing, for each class represented among the plurality of object instances:
an index for the class; and
a full name of the class;
a second table listing, for each class represented among the plurality of object instances:
a class index for the class;
a full name of a superclass of the class; and
a persistent field table identifying, for each persistent field of the class, a name of the persistent field and a type or class of the persistent field;
a third table listing, for each object instance among the plurality of object instances, the index of the class of the object instance; and
a linear dump of the values of the persistent fields for all object instances in the order of the third table.

31. The computer memories of claim 30 wherein the linear dump is comprised of compact bytecode representations of the persistent field values.
